(19) United States
(12) Patent Application Publication
(10) Pub. No.: US 2006/0256313 A1
(43) Pub. Date: Nov. 16, 2006

(54) Photolithographic imaging device and apparatus for generating an illumination distribution

(76) Inventors: Kerstin Renner, Dresden (DE); Christoph Nolscher, Nurnberg (DE); Thomas Muelders, Dresden (DE)

Correspondence Address: EDELL, SHAPIRO & FINNAN, LLC, 1901 RESEARCH BLVD., SUITE 400, ROCKVILLE, MD, 20850, US

(21) Appl. No.: 11/405,016

(22) Filed: Apr. 17, 2006

(30) Foreign Application Priority Data
Apr. 15, 2005 (DE) 10 2005 017 516.3

(51) Int. Cl. G03B 27/54

(52) U.S. Cl. 355/67; 355/53

(57) ABSTRACT

The imaging device has, in the illumination pupil region, an illumination distribution characterized by dipole-like light distributions along a straight line. The imaging device makes it possible to image different types of structures from a photomask simultaneously with a significantly better process window than conventional imaging devices.

### CROSS REFERENCE TO RELATED APPLICATIONS

This application claims priority under 35 USC § 119 to German Application No. DE 10 2005 017 516.3, filed on Apr. 15, 2005, and titled “Photolithographic Imaging Device and Apparatus for Generating an Illumination Distribution,” the entire contents of which are hereby incorporated by reference.

### FIELD OF THE INVENTION

The invention relates to an imaging device having an apparatus for generating an illumination distribution in an illumination pupil region for a photolithographic imaging of structures from a photomask into a photoresist layer above a semiconductor wafer. Further, the invention encompasses an apparatus for generating the illumination distribution and a method for determining the illumination distribution.

### BACKGROUND

Microelectronic circuits such as, for example, DRAM (dynamic random access memory) memory cells have patterned layers which are arranged on a semiconductor wafer and which comprise different materials, such as metals, dielectrics or semiconductor material. A photolithographic method is often employed for patterning the layers. In this case, a light-sensitive photoresist layer applied to the layer to be patterned is exposed to a light radiation in sections by a photomask having the structures to be transferred into the layer and a photolithographic imaging device. In the case of a positive photoresist, the exposed sections become soluble with respect to a developer solution and in the case of a negative photoresist the situation is reversed and so the exposed sections become insoluble with respect to the developer solution, while the unexposed sections are soluble.

After a development step, the structures are contained in the photoresist layer as openings in which the layer to be patterned is uncovered. The structures can subsequently be transferred into the underlying layer by a dry etching process.

The quality of the photolithographic imaging depends both on the type of structures in the photomask and on the type of illumination with which the structures are illuminated during the imaging operation. With the aid of simulation calculations, it is possible to adapt the structures in the photomask to a predetermined illumination situation, so that a desired target structure is imaged into the photoresist layer. Using a computer simulation, photomask structures can be calculated until the required target structures have been attained in the photoresist layer. Without any adaptation of the structures in the photomask, no process windows or only excessively small process windows would be produced for the desired target structure.

In the same way, the quality of the photolithographic imaging can be decisively improved by adapting the illumination distribution in the illumination pupil region of the imaging device to a predetermined structure in the photomask. The illumination pupil region is understood here to mean a luminous region that encompasses the entire opening of a condenser lens of the imaging device. It has long been known that, in many cases, a partially coherent illumination results in a better imaging quality by comparison with both completely coherent and completely incoherent illumination.

In the case of partially coherent illumination, light rays impinge on the photomask not from one angle, for example perpendicularly, as is the case with coherent axial illumination, but rather at a plurality of angles, i.e., also in oblique-angled fashion. FIG. 1 illustrates the oblique-angled illumination and the consequences for the imaging.

FIG. 1 illustrates the schematic of an imaging device 1. The illustration shows a light source 21, a condenser lens 22, an illumination pupil region 3, with an apparatus 31 for generating an illumination distribution 32, with the apparatus being formed as a diaphragm. The illumination distribution 32 is characterized by the circular opening illustrated in the diaphragm with a light intensity of 100%, by way of example. Outside the opening, the light intensity here in the illumination pupil region is 30%. Every punctiform sector from the circular opening constitutes a different illumination direction from which the photomask 4 is illuminated. The illustration shows an axial light ray A and an oblique-angled light ray B, which both impinge on the photomask 4 having structures 41. FIG. 1 likewise reveals an entrance pupil region 111 of a projection objective 11. As can be gathered from FIG. 1, higher diffraction orders of the light reach the entrance pupil region 111 in the case of oblique-angled illumination than in the case of axial illumination. The illustration shows the −1st and 0th diffraction order within the entrance pupil region 111 in the case of oblique-angled illumination. By contrast, the +1st diffraction order in the case of oblique-angled illumination and the +1st and −1st diffraction order in the case of axial illumination lie outside the entrance pupil region 111. The more diffraction orders contribute to the imaging, i.e., pass into the imaging projection objective 11, the better generally will be the imaged structure on the semiconductor wafer 5 illustrated.

When simultaneously imaging different types of structure in the photomask, which have different grating constants or spacings, for example, with the conventional illumination distributions, it is generally not possible to image all structure widths within predetermined tolerance ranges and with a sufficient process window.

The problem will be illustrated again using the example of the structures illustrated in FIGS. 2a and 2b .

FIG. 2a shows a detail from a line-gap grating 43 and FIG. 2b shows a detail from a more complicated structure with semi-isolated gaps, called SIG structure 42 for short hereafter.

The structures in accordance with FIG. 2 are to be imaged from the photomask into the photoresist layer in a predetermined tolerance range for the CDs (Critical Dimensions).

The line-gap grating may have a narrow grating constant g₁ in the region of kλNA, where λ denotes the exposure wavelength, k denotes a constant and NA denotes the numerical aperture. The center-to-center distance g₂ between two gaps from the SIG structure may be given by 0.4<g₂<0.7. During the production of the DRAM memory component, for example, in which the line-gap grating corresponds to the cell array, the imaged CDs including fluctuations in the focus of ±0.25 μm, in the exposure dose (in the photoresist layer) of ±2.5% and in other quantities should lie within a tolerance range of ±10% of the CD.

In order to determine an illumination distribution adapted to the structure that is respectively to be imaged, parameters of standard illumination distributions such as, for example, aperture angle, outer and inner radius, for example in the case of an annular illumination or a quadrupole illumination, are often optimized toward a respective criterion such as maximum process window, maximum contrast or some other parameter. The highly dimensional problem of finding an optimized illumination distribution is thereby reduced to a small number of parameters to be optimized. Many standard illumination distributions that are possible in principle, such as, for example, circular, annular or quadrupole, are often compared with one another. The possible parameters or parameter combinations can then be completely scanned for example by a numerical algorithm, the so-called NA-σ-scan, for all NA and illumination distributions.

Through experience, analogies drawn or other aids, it is possible to make a preliminary selection of the standard illumination distributions taken into consideration. In this case, an illumination pupil scan has to be performed for each relevant type of illumination, which scan occupies several hours or days depending on the required accuracy. Through the exclusive use of the standard illumination distributions, however, the relevant solution space for the illumination distribution to be optimized is greatly restricted from the outset.

A present-day solution for the single exposure of the 65 nm active area plane consists in the application of a quadrupole-like illumination distribution characterized by an outer radius of 0.96 and an inner radius of 0.76. The two types of structure, SIG and line-gap gratings, are imaged from a halftone phase shift mask (6%) into the photoresist layer. The process window produced under these conditions is very small, a value of less than 0.3 micrometer in the aerial image results for the depth of focus of the line-gap grating, and a value of less than 0.25 μm in the aerial image results for the depth of focus of the SIG structure.

FIG. 3 reveals a quadrupole-like illumination distribution 32 that is conventionally used to expose the structures in the photomask that are illustrated in FIG. 2. The light poles 321 discernible in FIG. 3, depicted white here, have a relative light intensity of 100%, while the hatched areas have a relative light intensity of 0%. The light poles 321 illustrated are arranged on an imaginary annulus that can be described by the outer and inner radii.

FIG. 4 graphically illustrates the contrast in the aerial image of the line-gap grating in the case of the quadrupole-like illumination distribution as a function of the defocus. The defocus in micrometers is plotted on the abscissa and the contrast in dimensionless units is plotted on the ordinate. The curve illustrated in FIG. 4 describes the dependence of the contrast on the defocus. As can be gathered from the curve, for the defocus of 0.15 μm, the contrast has already fallen to a value of almost 43% which is unacceptable for lithographic imaging. Given a defocus of 0.15 μm, therefore, the line-gap grating is certainly no longer imaged onto the semiconductor wafer with a sufficient quality.

The light intensity in the aerial image of the SIG structure can be gathered from FIGS. 5A-5C. FIG. 5A shows the location-dependent intensity distribution for the best focal position. The spatial coordinates x and y in micrometers are plotted on the ordinate and the abscissa. The various gray shades in the figure correspond to different intensity values. The regions depicted dark-gray have the lowest intensity value. The lighter the gray-shade value, the higher the intensity of the light. As can be gathered from FIG. 5A, the structures are still imaged dimensionally accurately in the best focal position. A different image results in accordance with FIG. 5B; in contrast to FIG. 5A, it was calculated for a defocus of 0.125 μm. Both aerial images were calculated by a simulation program. Weak points are already discernible in FIG. 5B. The SIG gaps are in part no longer completely open. A defocus of 0.15 μm was taken as a basis for FIG. 5C. The trend already discernible in FIG. 5B is additionally amplified in the case of further defocusing. As can be gathered from FIG. 5C, the gaps of the SIG structure are no longer open.

### SUMMARY

The present invention provides an imaging device having an apparatus for generating an illumination distribution which enables simultaneous imaging of different types of structure from a photomask into a photoresist layer on a semiconductor wafer with an enlarged process window by comparison with conventional imaging devices. In particular, an optical imaging device includes an apparatus for generating an illumination distribution in an illumination pupil region for a photolithographic imaging of structures from a photomask into a photoresist layer above a semiconductor wafer. The illumination distribution generated by the apparatus has more than two light poles, all of the light poles being arranged in the illumination pupil region such that they lie on one and the same axis of an imaginary x, y axis system, the origin of which is situated at the center of the illumination pupil region.

The light pole is understood here to mean a delimited sector from the illumination pupil region whose light intensity is higher than that of the rest of the illumination pupil region surrounding the light pole. It was possible to demonstrate with the aid of simulation calculations that an illumination distribution comprising two dipoles, i.e., comprising in total four light poles arranged in a straight line, results in a significant improvement in the lithographic imaging quality compared with imaging devices with conventional illumination distributions for a simultaneous imaging of an SIG structure provided in the photomask and a line-gap grating. In this case, the photomask may be, for example, a halftone phase shift mask or a binary mask or a chromeless mask with 180 degrees phase jumps. The process window is extended through an improvement in the imaging quality. With an extended process window, it is possible to avoid faults that lie outside the specification and would render the semiconductor wafer unusable. As a result, costs can be lowered and a higher productivity can be achieved.

A dipole-like illumination distribution is advantageous for the imaging of a structure dominated by one grating constant. If the photomask is provided with two different types of structure, for example SIG and line-gap gratings, which are dominated by one respective grating constant, then one of the two dipoles can be optimized for the imaging of the SIG structure and the other of the two dipoles can be optimized for the imaging of the line-gap grating. It is also conceivable that, given the presence of more than two different types of structure which are dominated by one respective grating constant, a dipole-like illumination distribution may be provided for each type of structure. This would then result in imaging devices having illumination distributions which have four or six or even more light poles on one axis. In the case of more complex structures, it may also be advantageous to provide still further light poles outside the light poles arranged in a straight line.

The illumination distribution is advantageously axially symmetrical with respect to the x axis and the y axis of the x, y axis system. If the light poles lie on the y axis, by way of example, then the axial symmetry means that the center of the areally extended light pole lies on the y axis. Symmetrical with respect to the x axis means that each light pole which lies above the x axis on the y axis has a partner mirrored at the x axis below the x axis.

Preferably, an even number of light poles are provided, two light poles that are at an identical distance from the origin in each case forming a dipole-like light distribution. That is, the light pole above the x axis and its mirrored partner below the x axis form the dipole-like light distribution. Dipole-like light distributions can be used particularly advantageously for the imaging of structures that are dominated by one grating constant.

The dipole-like light distributions may advantageously have integral light intensities that are in each case different from one another. The total light intensity of one dipole-like light distribution may therefore deviate from the total light intensity of another dipole-like light distribution in the illumination distribution. The integral light intensity of the light poles can be adapted in accordance with the tolerances of the critical structures and the quality of the imaging device, in particular taking account of the apodization of the projection optic. If, by way of example, the transmission of the lens system of the imaging device is only tᵢ% at the location of the inner light poles nearer to the center of the illumination pupil region, but is tₒ% at the location of the outer light poles, where tₒ>tᵢ, then the inner light poles are realized in larger fashion in the ratio tₒ/tᵢ. Optionally, the dipole-like light distributions may all have the same integral light intensity.

The illumination distribution advantageously has four light poles. The four light poles form two dipole-like light distributions, an inner dipole-like light distribution nearer to the center of the illumination pupil region and an outer dipole-like light distribution more remote from the center of the illumination pupil region. With the two dipole-like light distributions, it is possible, in a preferred manner, to simultaneously image the SIG structure and the line-gap grating from the photomask. In this case, the inner dipole-like illumination distribution is optimized relative to the SIG structure and the outer dipole-like illumination distribution is optimized relative to the line-gap grating. In this case, the integral light intensity of the outer dipole-like light distribution may be greater than or equal to the integral light intensity of the inner dipole-like light distribution. The opposite case where the integral intensity of the inner dipole-like light distribution is greater than that of the outer dipole-like light distribution is also possible.

With the use of the imaging device having the double-dipole-like illumination distribution described, it is possible to achieve a decisive improvement in the imaging for the existing photomask layout with the SIG structure and the line-gap grating. The illumination distribution according to the invention affords the advantage that both the line-gap grating and the periphery, in particular the SIG structure, can be imaged in one lithographic step of a single exposure and a sufficient process window can nevertheless be obtained. By comparison with the conventional quadrupole illumination, the advantage consists in a greater weighting of the dipole-like light distribution that determines the line-gap grating imaging, so that the line-gap grating is imaged better in the process window, and also in an adaptation of the second dipole-like light distribution to the geometry of the second critical structure, for example SIG structure, for the purpose of enlarging the process window.

An apparatus for generating the illumination distribution in the illumination pupil region of the imaging device for the photolithographic imaging of structures from the photomask into the photoresist layer above the semiconductor wafer is made available. According to the invention, the illumination distribution generated by the apparatus has the features described above. The apparatus can be formed as a diaphragm. However, it is also possible for the apparatus to be formed as a diffractive optical element or as a lens system.

A method for determining the illumination distribution in the illumination pupil region of the imaging device described is made available. According to the invention, the illumination distribution is provided in a manner comprising the dipole-like light distributions described, and the distances between the light poles forming the dipole-like light distributions are defined by distances between the structures in the photomask. The position of the light poles in the illumination pupil region is defined by grating constants g occurring in the layout of the photomask in accordance with σ_{center}=0.5 λ/g/NA, where the distance between the light poles in the dipole-like light distribution can be described by σ_{center}. By way of example, the SIG structure and the line-gap grating are described by two different grating constants, the line-gap grating being described by one grating constant and the SIG structure essentially being described by a further grating constant. The SIG structure is more complicated in comparison with the line-gap grating, but is dominated by the bar structure that is oriented parallel to the line-gap grating and can be assigned a grating constant. Simultaneous imaging of the SIG structure and the line-gap grating can thus be optimized by means of the double dipole-like light distribution. The distances between the light poles which form the respective dipole-like light distribution are then determined using the formula specified above.

### BRIEF DESCRIPTION OF THE DRAWINGS

The invention is explained in more detail below with reference to the figures in which:

FIG. 1 shows a simplified illustration of an imaging device,

FIGS. 2A and 2B show a diagram of a line-gap grating structure and of an SIG structure,

FIG. 3 shows a conventional illumination distribution,

FIG. 4 shows contrast as a function of the defocus in the aerial image of the line-gap grating,

FIGS. 5A-5C show aerial images of the SIG structure generated by a conventional imaging device,

FIGS. 6A-6L show sectional lines through the SIG structure and the line-gap grating,

FIG. 7 shows an optimized illumination distribution for an imaging device according to the invention,

FIG. 8 shows contrast as a function of the defocus in the aerial image of the line-gap grating with an optimized illumination distribution,

FIGS. 9A-9C show aerial images of the SIG structure with an optimized illumination distribution,

FIGS. 10A-L, 11A-L, and 12A-L show conventional and optimized illumination distributions and aerial images of the SIG structure in comparison with one another.

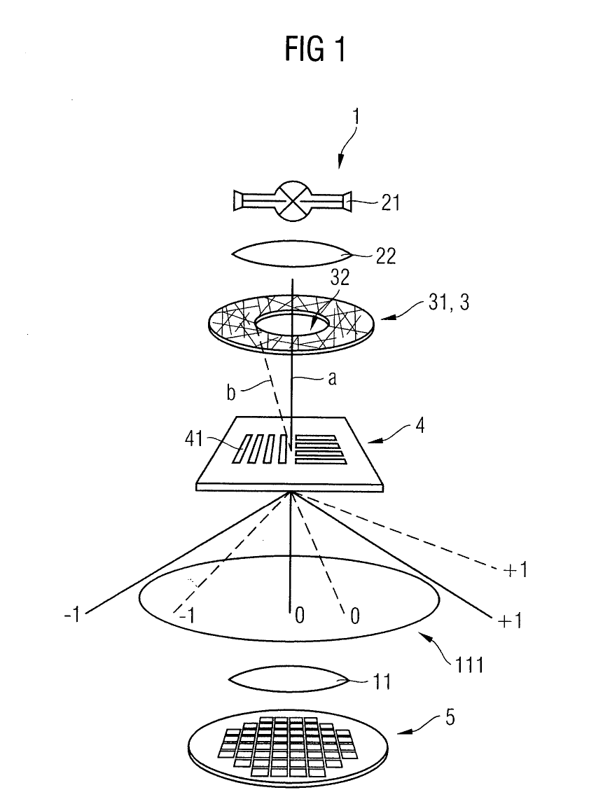

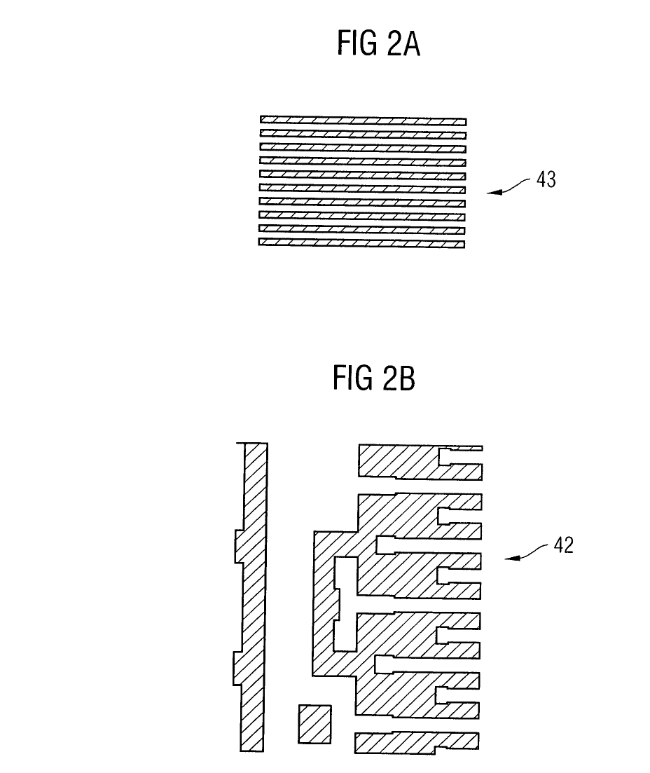

### DETAILED DESCRIPTION

In order to verify the quality of imaging devices 1 according to the invention, which differ from conventional imaging devices 1 by virtue of their optimized illumination distribution 32, simulation calculations are performed. In this case, the aerial images, generated in the case of a specific illumination distribution 32, of the SIG structure 42 and of the line-gap grating 43 which are contained in a photomask 4 are calculated and assessed. The aerial image represents an intensity distribution of the light in the image space. In order to prevent the computational times from becoming excessively long and in order nevertheless to be able to make a statement about the imaging quality, the aerial image is evaluated along a plurality of sectional lines 411. For the assessment of the imaging of the line-gap grating structure 43, it suffices to evaluate the aerial image along a sectional line 411 through the line-gap grating structure 43. On account of the complexity of the SIG structure 42, the aerial images along eleven sectional lines 411 through the SIG structure 42 were assessed.

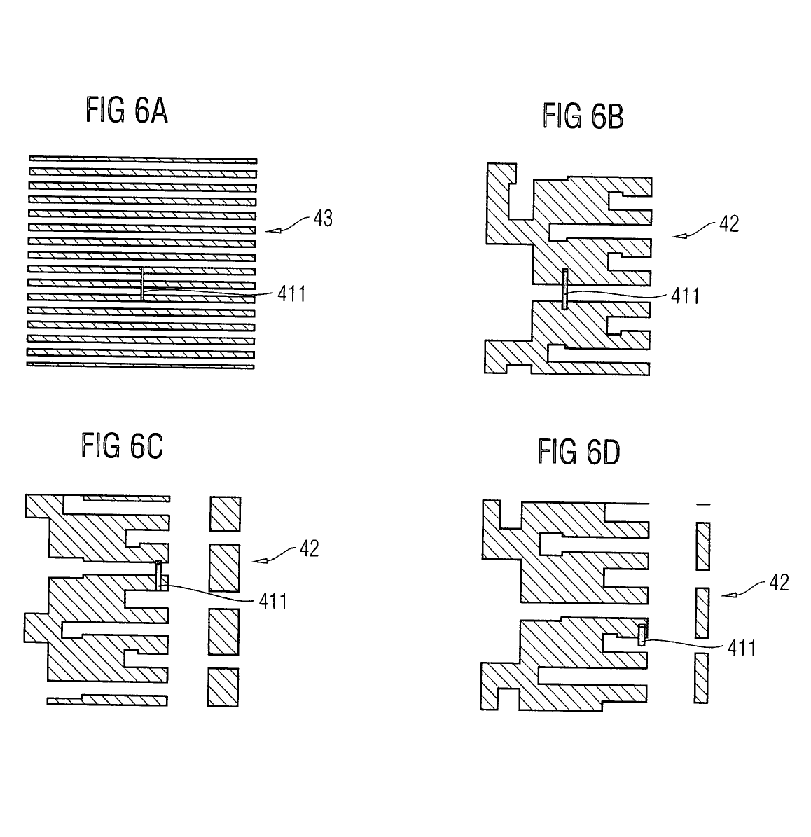

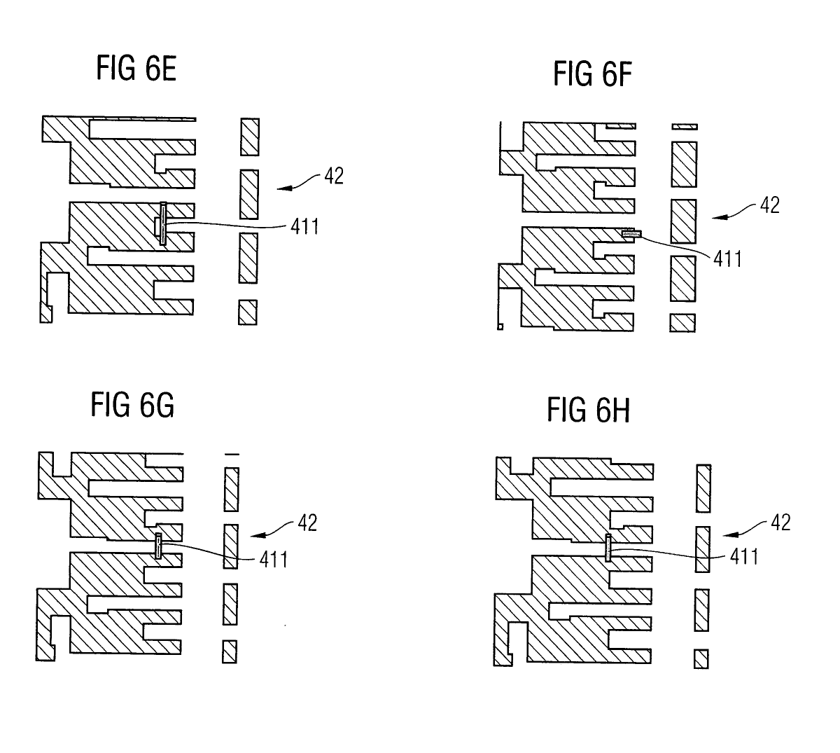

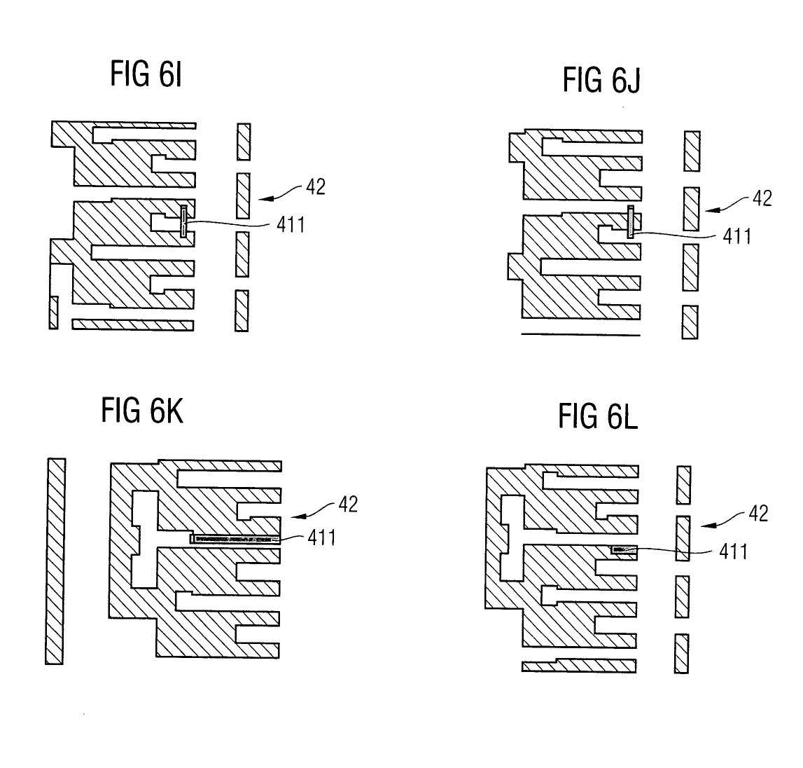

FIG. 6A reveals the sectional line 411 through the line-gap grating structure 43. FIGS. 6B to 6L respectively show details of eleven sectional lines 411 through the SIG structure 42.

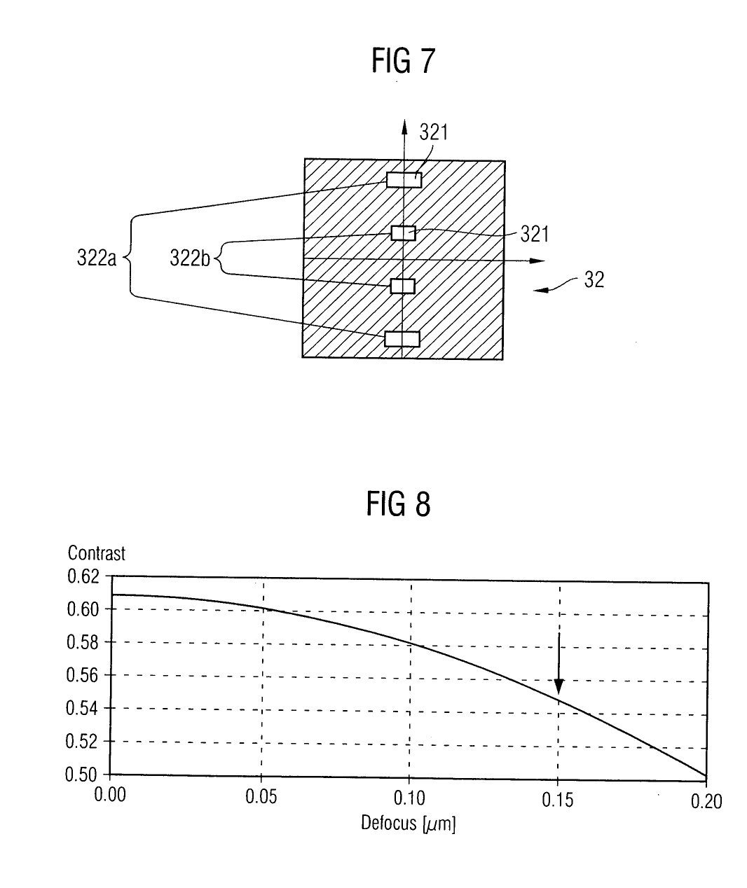

FIG. 7 illustrates a first variant of an illumination distribution 32 optimized for an imaging device according to the invention, for which the aerial images along the sectional lines in accordance with FIGS. 6A-6L were assessed. The illumination distribution 32 comprises light poles 321, which are depicted as bright rectangles in FIG. 7. The light poles 321 have a higher light intensity than the surrounding region, shown hatched here. All four light poles 321 depicted lie with their center on the y axis of an imaginary x, y axis system depicted here. As can be gathered from FIG. 7, the light poles 321 are distributed axially symmetrically. Two light poles 321 at the same distance from the origin of the axis system in each case form a dipole-like light distribution 322. A distinction is made between the inner dipole-like illumination distribution 322b depicted and the outer dipole-like illumination distribution 322a depicted. In accordance with FIG. 7, the light poles 321 are formed as rectangles, the light poles of the outer dipole-like light distribution 322a having larger dimensions than the light poles 321 of the inner dipole-like light distribution 322b.

The contrast in the aerial image as a function of the defocus was used as an assessment criterion for the imaging quality.

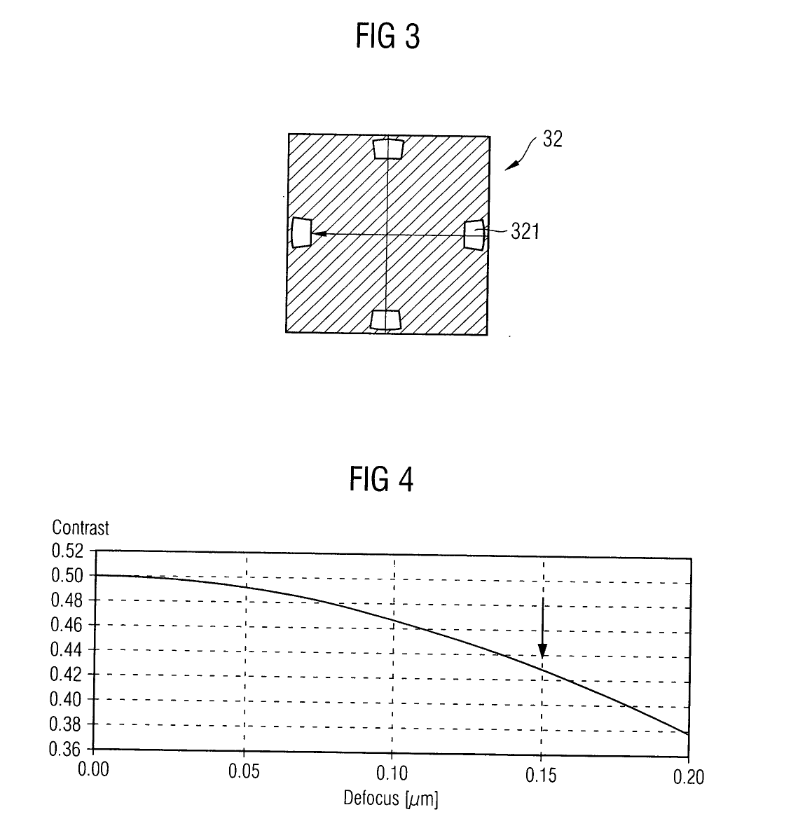

FIG. 8 illustrates the contrast in the aerial image of the line-gap grating 43 for the optimized illumination distribution 32 in accordance with FIG. 7 as a function of the defocus. By way of example, the light poles 321 for the outer dipole-like light distribution 322a have the dimensions 0.15×0.3, and the light poles 321 for the inner dipole-like light distribution 322b have the dimensions 0.15×0.2. The defocus in micrometers is plotted on the abscissa and the contrast in dimensionless units is plotted on the ordinate. The curve describes the dependence of the contrast on the defocus. As can be gathered from the curve, the contrast has a value of 55% for a defocus of 0.15 μm. This value is significantly greater than the value which was obtained with the nonoptimized illumination distribution 32 in accordance with FIG. 3 and was 43%.

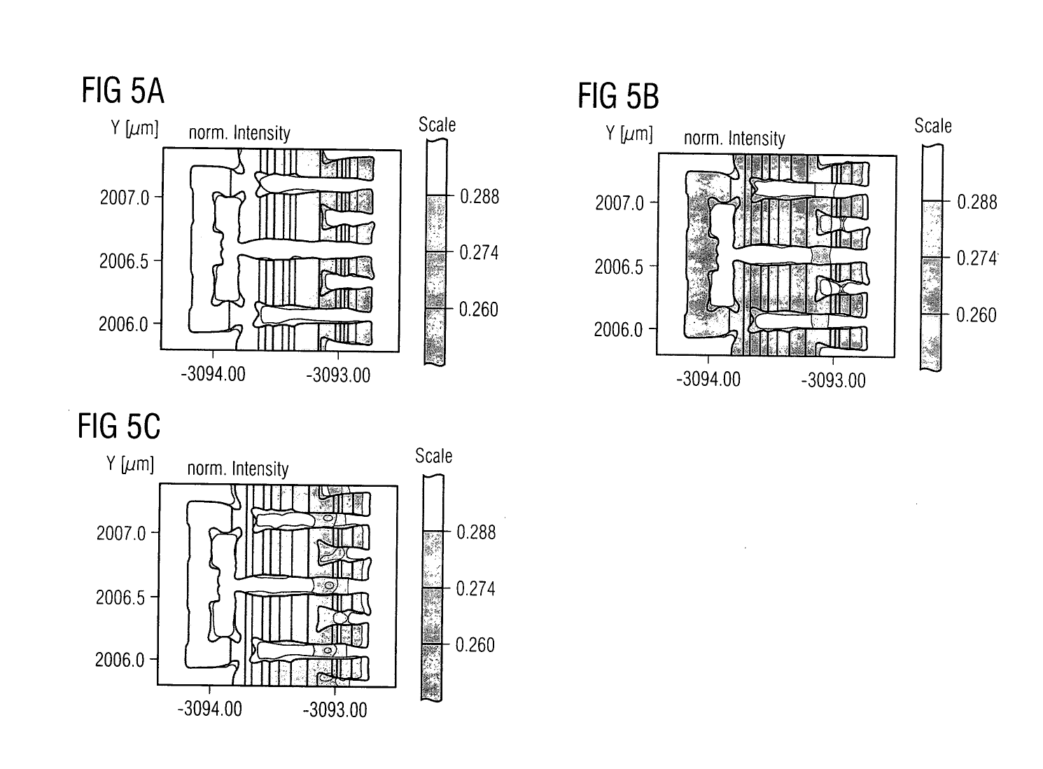

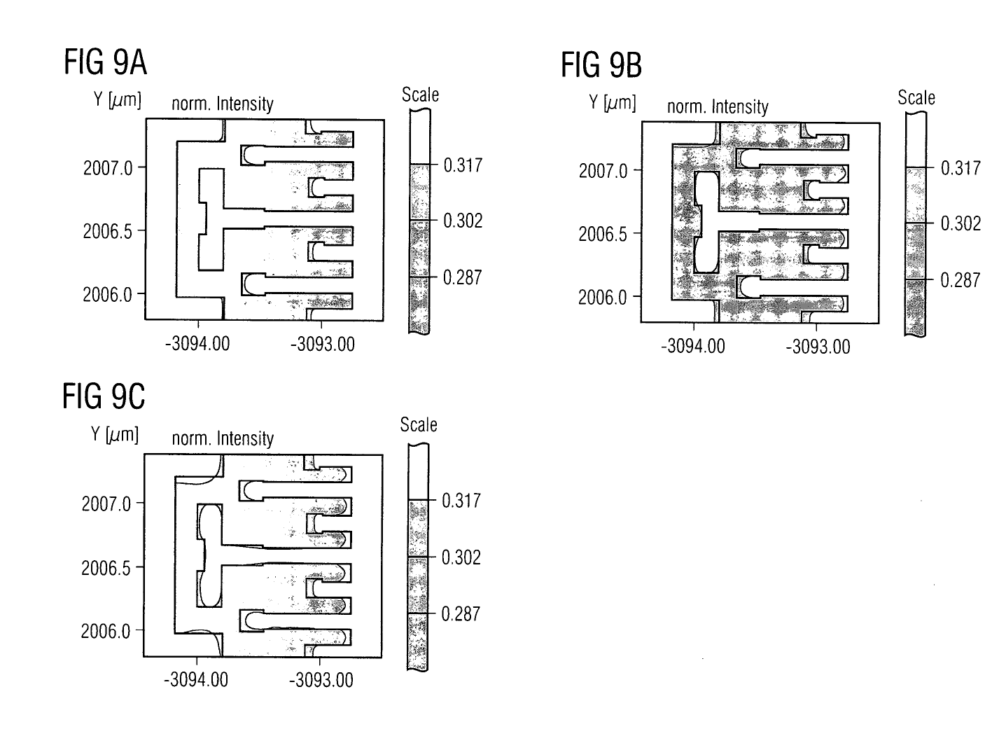

FIGS. 9A-9C illustrate the aerial image of the SIG structure 42 in accordance with FIG. 6L for three different focus settings a) optimal focus, b) defocus 0.125 μm, c) defocus 0.15 μm. The aerial images with the illumination distribution 32 specified in the description relating to FIG. 8 were calculated. The gray-scale degradations and the axis captions correspond to those of FIGS. 5A-5C. As can be gathered from FIG. 9A, no critical regions result for the best focal position. The structures are imaged with a high quality with regard to the contrast and the dimensional accuracy. FIG. 9B illustrates the aerial image in the case of a defocus of 0.125 μm. As is evident, the SIG structure 42 is imaged with a very high quality even in defocus. All gaps are open and the lines are still imaged almost dimensionally accurately. A similar result arises in the case of a defocus of 0.15 μm, illustrated in FIG. 9C. Here, too, a significantly higher imaging quality is achieved with the optimized illumination distribution 32 than with the nonoptimized illumination distribution 32 in accordance with FIG. 3.

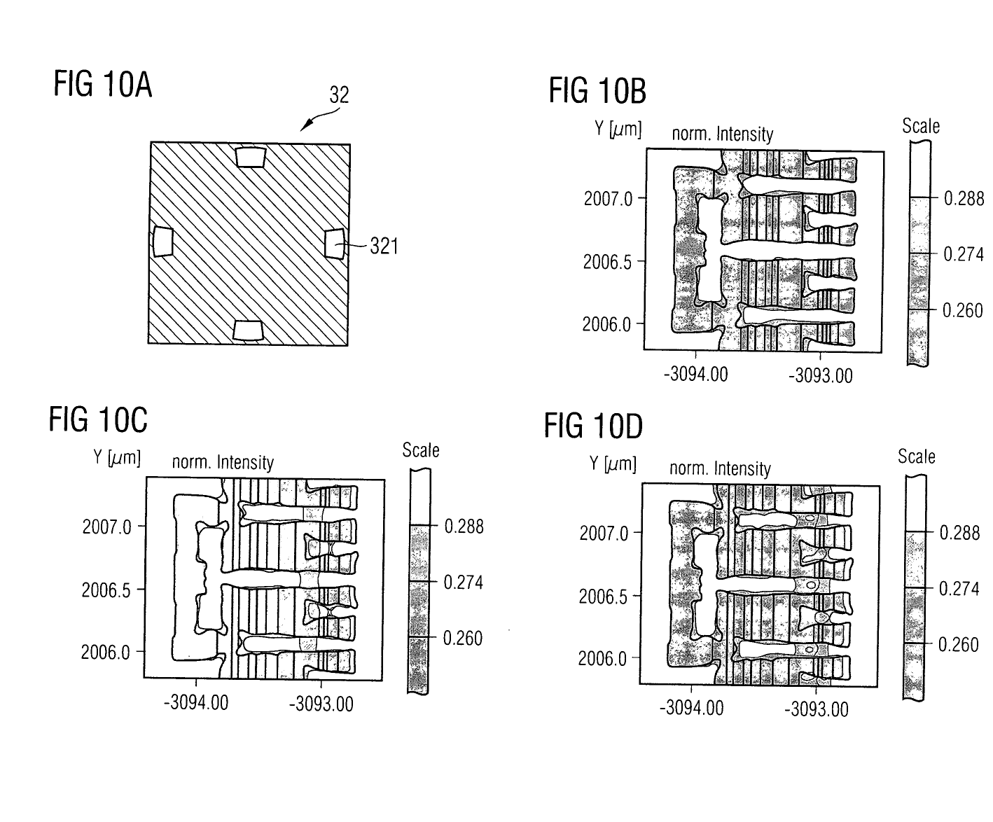

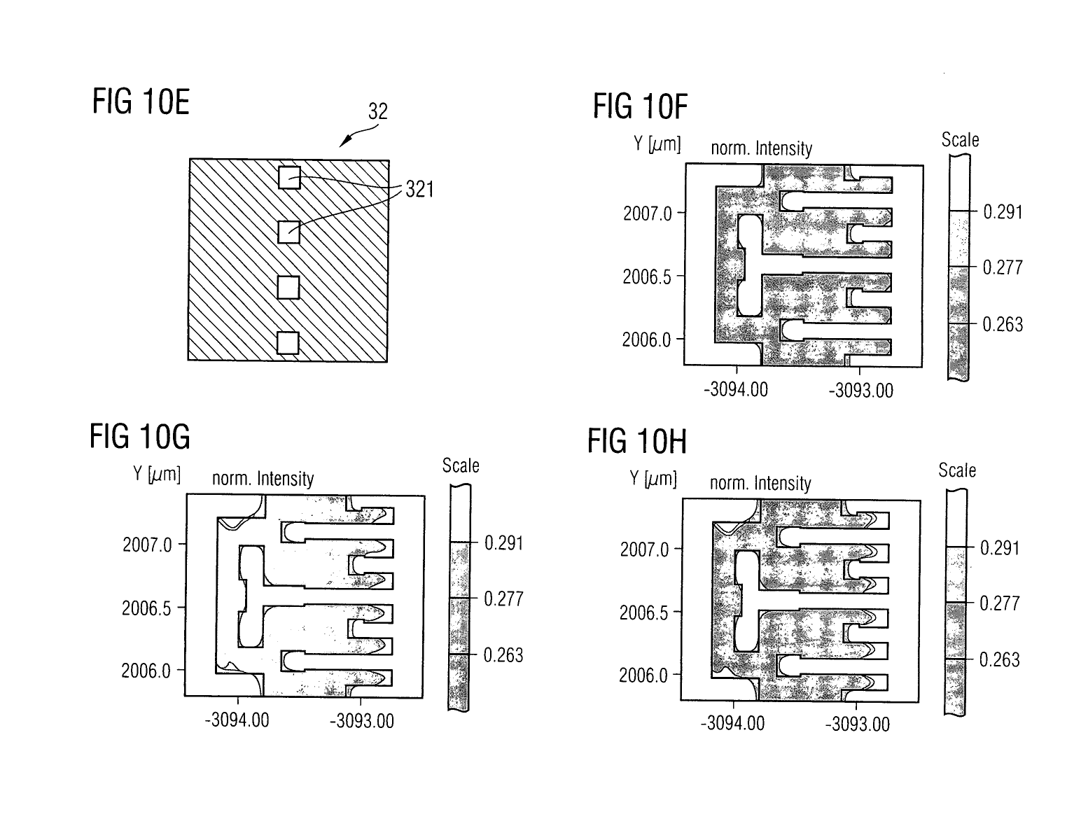

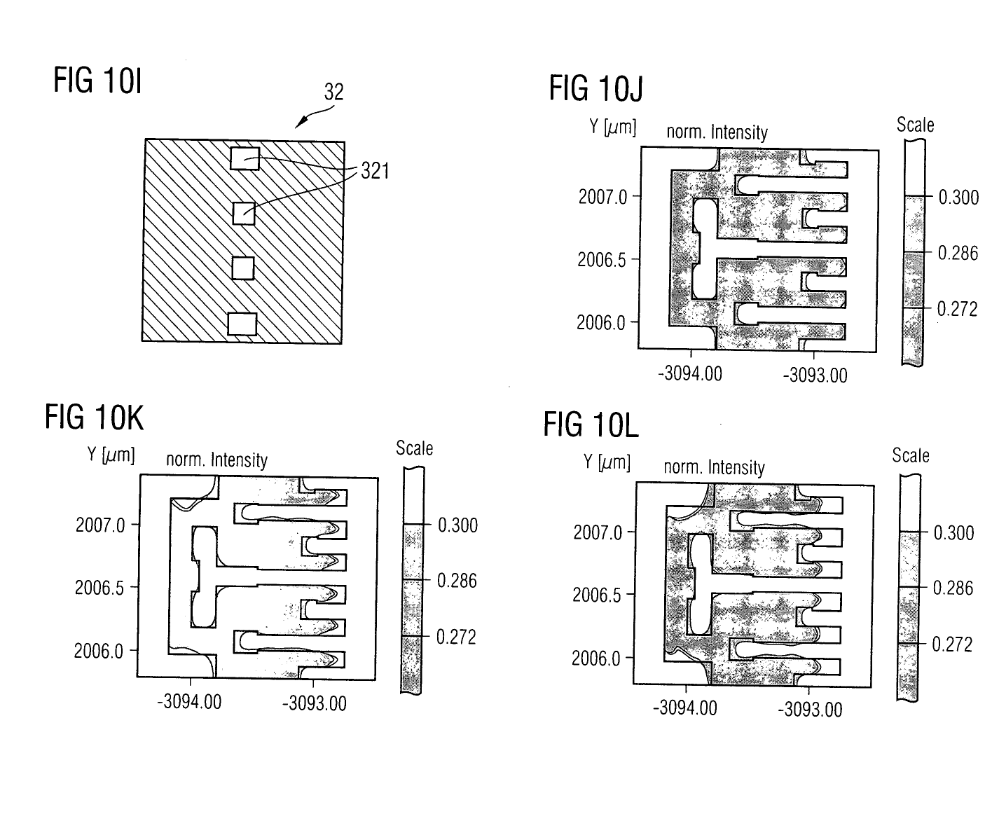

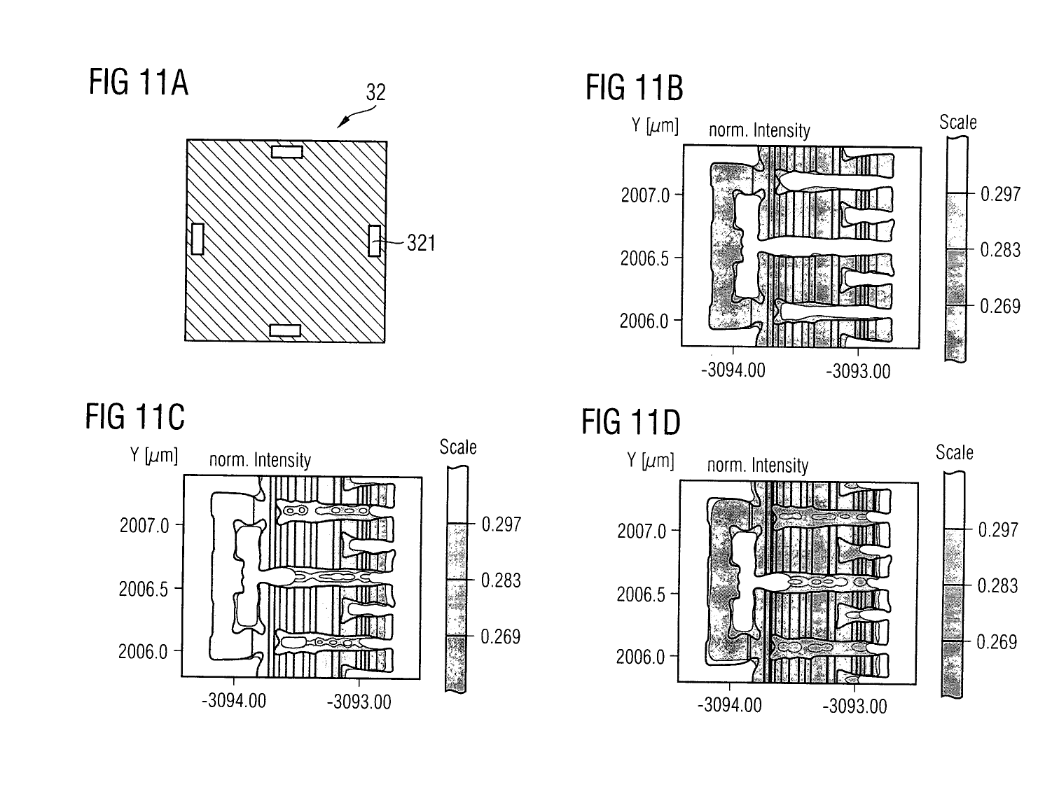

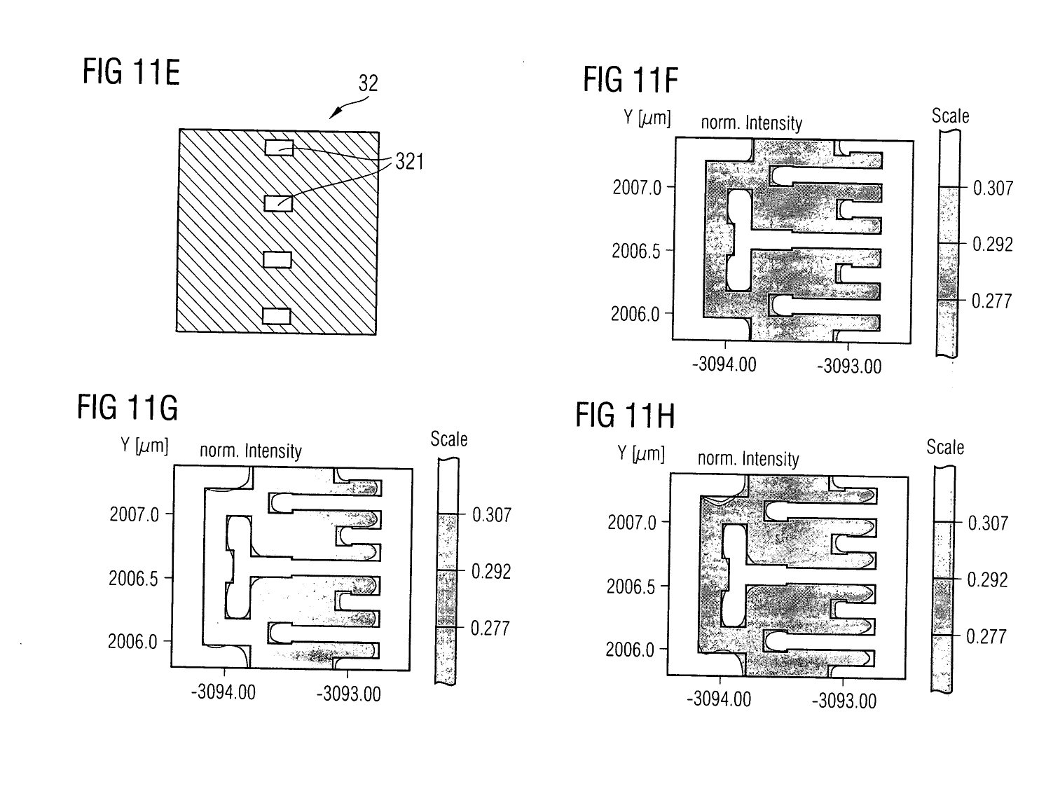

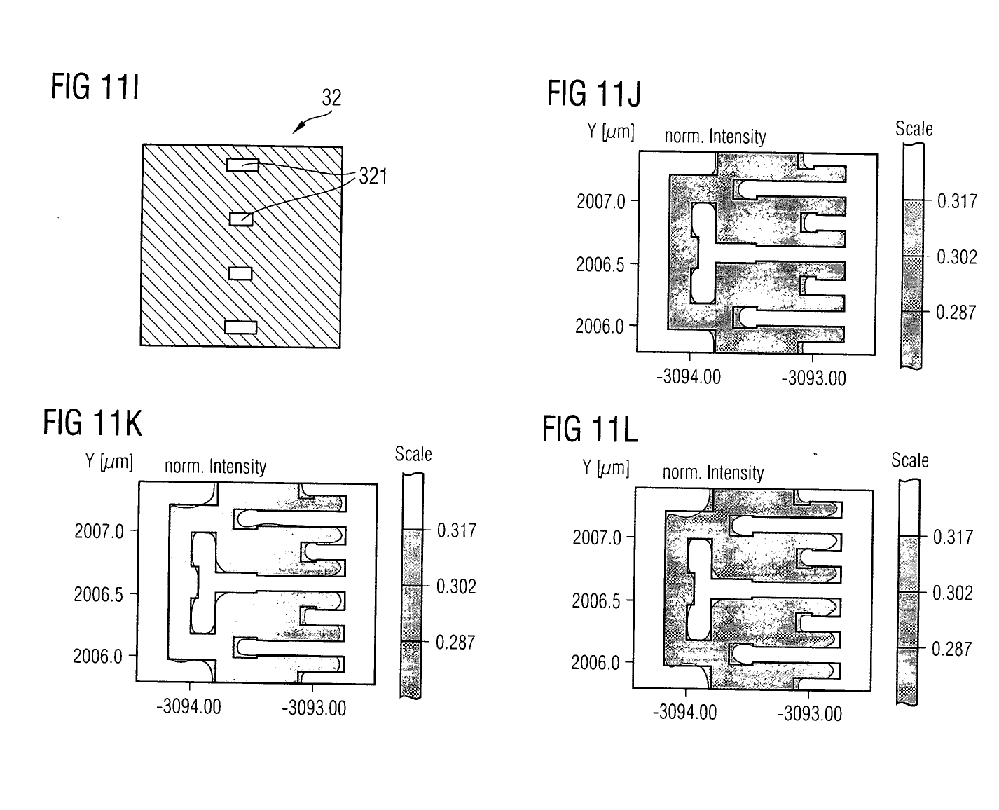

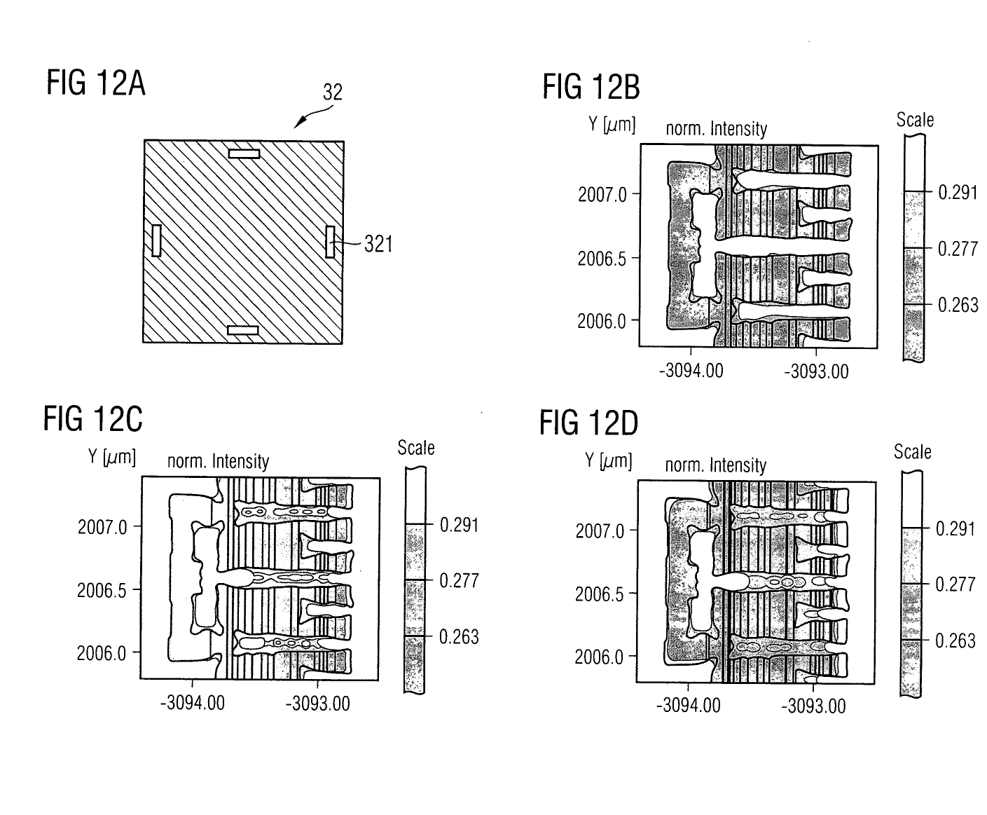

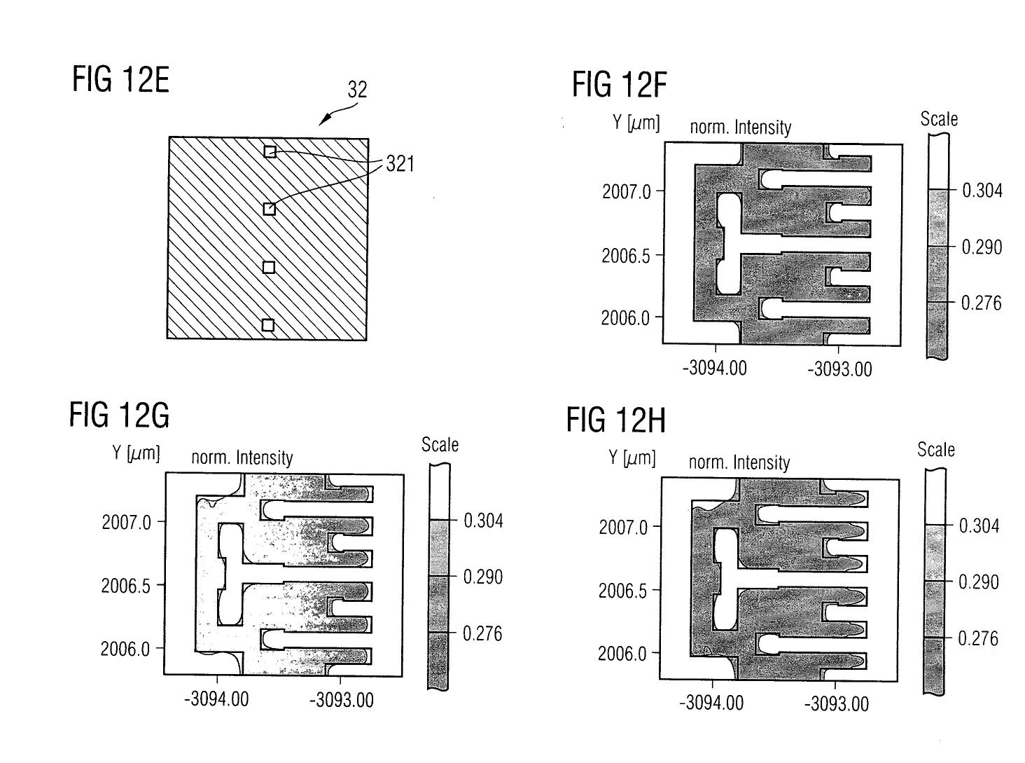

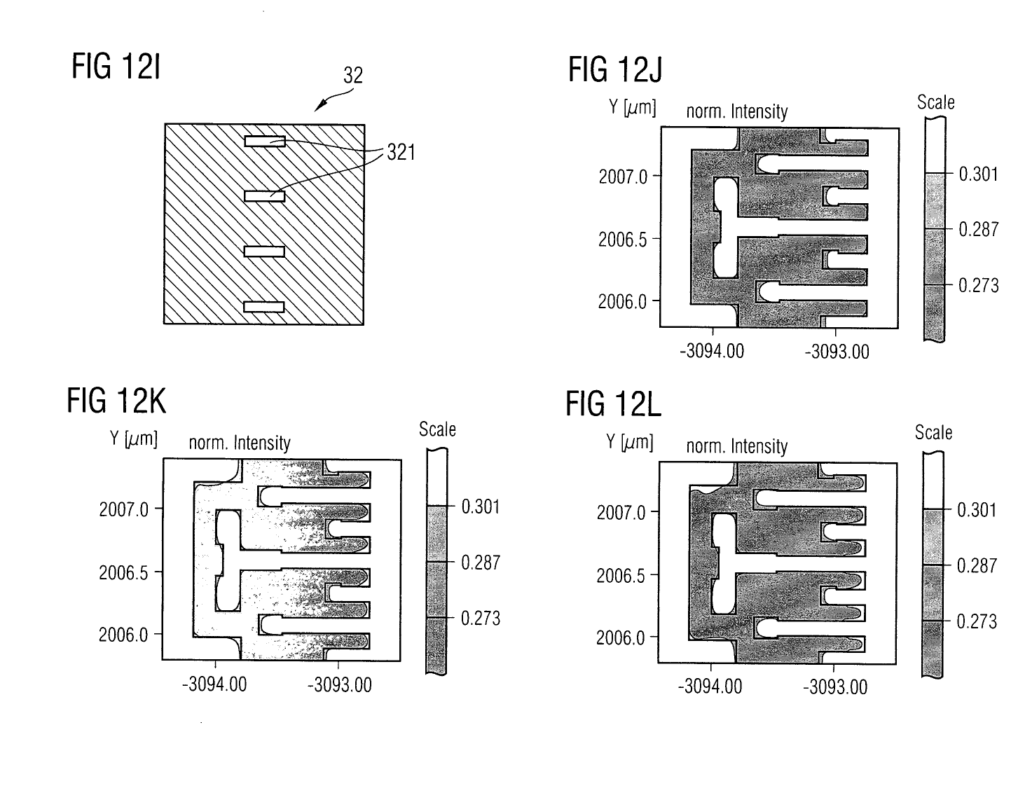

The imaging device 1 having the optimized illumination distribution 32 in accordance with FIG. 7 thus achieves a significantly higher imaging quality and thus also a larger process window than the imaging device 1 having the nonoptimized illumination distribution 32. In FIGS. 10A-12L, aerial images that were calculated for different variants of optimized illumination distributions 32 are once again compared with those that were calculated for nonoptimized conventional illumination distributions 32.

FIG. 10A shows the conventional quadrupole-like illumination distribution 32 with light poles 321 on the x axis and the y axis. A value of 0.76 is specified for the inner radius Rᵢ and a value of 0.96 is specified for the outer radius Rₒ. The width of the light poles is calculated from the difference between inner radius and outer radius as 0.2. In the case of a defocus of 0.15 μm, a remaining contrast of 43% is determined in the aerial image of the line-gap grating structure 43.

FIGS. 10B, 10C, and 10D show the aerial image of the SIG structure 42 that was calculated with the illumination distribution 32 in accordance with FIG. 10A—for the best focus, FIG. 10B, for a defocus of 0.125 μm, FIG. 10C, and a defocus of 0.15 μm, FIG. 10D. As can be gathered from the figures the structures are no longer imaged dimensionally accurately in the case of a defocus of 0.125 μm. In addition, the gaps are no longer completely open. This trend can be observed to be amplified in the case of a defocus of 0.15 μm.

In the case of the optimized illumination distribution 32 in accordance with FIG. 10E, all the light poles 321 are arranged on one axis and have the same size. The radii for the outer dipole-like light distribution 322a are 0.76 and 0.96. The dimensions of all the light poles 321 are 0.2×0.2. The radii for the inner dipole-like illumination distribution 322b are specified with 0.2 and 0.4. The contrast in the aerial image of the line-gap grating 43 was calculated as 46% in the case of this optimized illumination distribution, i.e., an improvement over the conventional illumination distribution 32 in accordance with FIG. 10a. The aerial images of the SIG structure 42 in the case of the illumination distribution 32 can be gathered from FIGS. 10F, 10G and 10H. FIG. 10F shows the aerial image in the case of the best focus setting, FIG. 10G in the case of a defocus of 0.125, and FIG. 10H in the case of a defocus of 0.15. As can be gathered from FIG. 10F, the SIG structure 42 is imaged significantly more dimensionally accurately in the case of the optimized illumination distribution 32 in accordance with FIG. 10E than in the case of the conventional illumination distribution 32. The aerial images 10G and 10H exhibit slight deviations in the dimensional accuracy, but the gaps remain open. In comparison with the conventional illumination distribution 32, the aerial images of FIGS. 10F, 10G, and 10H have a significantly better imaging quality.

The illumination distribution 32 in accordance with FIG. 10I differs from the illumination distribution of FIG. 10E in that the light poles 321b of the inner dipole-like light distribution 322b have different dimensions than the light poles 321 of the outer dipole-like light distribution 322a. The dimensions for the light poles 321 of the outer dipole-like light distribution 322a turn out to be 0.2×0.3 and the dimensions for the light poles 321 of the inner dipole-like light distribution 322b turn out to be 0.2×0.2. With this illumination distribution 32, the contrast in the aerial image of the line-gap grating is calculated as 52% in the case of a defocus of 0.15 μm. The illumination distribution 32 in FIG. 10I thus constitutes a further improvement with regard to the contrast in the line-gap grating 43. The aerial images of the SIG structure 42 for focal positions described above are contained in FIGS. 10J, 10K, and 10L. Comparison of the aerial images of FIGS. 10J, 10K, and 10L with those of FIGS. 10F, 10G, and 10H yields no significant differences. The imaging quality is in any event significantly improved compared with the conventional illumination distribution.

The conventional quadrupole-like illumination distribution 32 in accordance with FIG. 11A differs from the illumination distribution 32 in accordance with FIG. 10A with regard to the inner radius Rᵢ, which in this case has the value of 0.78, and the outer radius Rₒ, which in this case has the value of 0.93. The width of the light poles is calculated as 0.15. In the case of a defocus of 0.15 μm, a remaining contrast of 47% is determined in this case in the aerial image of the line-gap grating structure 43.

FIGS. 11B, 11C, and 11D show the aerial image of the SIG structure 42 that was calculated with the illumination distribution 32 in accordance with FIG. 11A—for the best focus, FIG. 11B, for a defocus of 0.125 μm, FIG. 11C, and a defocus of 0.15 μm, FIG. 11D. As can be gathered from the figures, the structures are imaged more dimensionally accurately in the case of a defocus of 0.125 μm than in the case of the illumination distribution in accordance with FIG. 10A. Moreover, the gaps are still completely open. In the case of a defocus of 0.15 μm, however, the imaging quality is as poor as or even worse than that in the case of the illumination distribution in accordance with FIG. 10A.

The optimized illumination distribution 32 illustrated in FIG. 11Ee differs from that in accordance with FIG. 10E by virtue of the radii. The radii for the outer dipole-like light distribution 322a are 0.78 and 0.93. The dimensions of all the light poles 321 are 0.15×0.27. The radii for the inner dipole-like illumination distribution 322b are specified with 0.23 and 0.38. The contrast in the aerial image of the line-gap grating 43 was calculated as 51% in the case of this optimized illumination distribution, i.e., an improvement over the conventional illumination distribution 32 in accordance with FIG. 11A. The aerial images of the SIG structure 42 in the case of this illumination distribution 32 can be gathered from FIGS. 11F, 11G, and 11H. FIG. 11F shows the aerial image in the case of the best focus setting, FIG. 11G in the case of a defocus of 0.125 μm, and FIG. 11H in the case of a defocus of 0.15 μm. As can be gathered from FIG. 11F, the SIG structure 42 is imaged dimensionally accurately in the case of the optimized illumination distribution 32 in accordance with FIG. 11E. The aerial images 11G and 11H exhibit slight deviations in the dimensional accuracy, but the gaps remain open throughout. The aerial images of FIGS. 11F, 11G, and 11H have a significantly better imaging quality in comparison with the conventional illumination distribution 32.

The illumination distribution 32 in FIG. 11I differs from the illumination distribution in accordance with FIG. 11E in that the light poles 321b of the inner dipole-like light distribution 322b have different dimensions than the light poles 321 of the outer dipole-like light distribution 322a. The dimensions for the light poles 321 of the outer dipole-like light distribution 322a turn out to be 0.15×0.27 and the dimensions for the light poles 321 of the inner dipole-like light distribution 322b turn out to be 0.15×0.2. With this illumination distribution 32, the contrast in the aerial image of the line-gap grating is calculated as 55% in the case of a defocus of 0.15 μm. The illumination distribution 32 in accordance with FIG. 11I thus constitutes a further improvement with regard to the contrast in the line-gap grating 43. The aerial images of the SIG structure 42 for focal positions described above are contained in FIGS. 11J, 11K, and 11L. Comparison of the aerial images of FIGS. 11J, 11K, and 11L with those of FIGS. 11F, 11G, and 11H yields no significant differences. The imaging quality compared with the conventional illumination distribution is significantly improved, however.

The conventional quadrupole-like illumination distribution 32 in accordance with FIG. 12A differs from the illumination distribution 32 in accordance with FIG. 11A with regard to the inner radius Rᵢ, which in this case has the value of 0.81, and the outer radius Rₒ, which in this case has the value of 0.91. The width of the light poles is calculated as 0.1. In the case of a defocus of 0.15 μm, a remaining contrast of 48% is determined in this case in the aerial image of the line-gap grating structure 43.

FIGS. 12B, 12C, and 12D show the aerial image of the SIG structure 42 that was calculated with the illumination distribution 32 in accordance with FIG. 12A—for the best focus, FIG. 12B, for a defocus of 0.125 μm, FIG. 12C, and a defocus of 0.15 μm, FIG. 12D. As can be gathered from the figures, in the case of a defocus of 0.125 μm and a defocus of 0.15 μm the structures are imaged with a quality similar to that in the case of the illumination distribution 32 in accordance with FIG. 11A.

The optimized illumination distribution 32 illustrated in FIG. 12E differs from that in accordance with FIG. 11E by virtue of the radii. The radii for the outer dipole-like light distribution 322a are 0.81 and 0.91. The dimensions of all the light poles 321 are 0.1×0.1. The radii for the inner dipole-like illumination distribution 322b are specified with 0.25 and 0.35. The contrast in the aerial image of the line-gap grating 43 was calculated as 54% in the case of this optimized illumination distribution 32, i.e., an improvement over the conventional illumination distribution 32 in accordance with FIG. 12A. The aerial images of the SIG structure 42 in the case of the illumination distribution 32 can be gathered from FIGS. 12F, 12G, and 12H. FIG. 12F shows the aerial image in the case of the best focus setting, FIG. 12G in the case of a defocus of 0.125 μm and FIG. 12H in the case of a defocus of 0.15 μm. As can be gathered from FIG. 12F, the SIG structure 42 is imaged dimensionally accurately in the case of the optimized illumination distribution 32 in accordance with FIG. 12E. The aerial images 12G and 12H exhibit slight deviations in the dimensional accuracy and the gaps remain open throughout. The aerial images of FIGS. 12F, 12G, and 12H have a significantly better imaging quality in comparison with the conventional illumination distribution 32.

The illumination distribution 32 illustrated in FIG. 12I differs from the illumination distribution in accordance with FIG. 12E in that all the light poles 321 have the dimensions 0.1×0.4. With this illumination distribution 32, the contrast in the aerial image of the line-gap grating is calculated as 55% in the case of a defocus of 0.15 μm. The illumination distribution 32 in accordance with FIG. 12I thus constitutes a further improvement with regard to the contrast in the line-gap grating 43. The aerial images of the SIG structure 42 for focal positions described above are contained in FIGS. 12J, 12K, and 12L. Comparison of the aerial images of FIGS. 12J, 12K, and 12L with those of FIGS. 12F, 12G, and 12H yields no significant differences. The imaging quality compared with the conventional illumination distribution is significantly improved, however.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

List of reference symbols

1 Imaging device
11 Projection objective
11I Pupil region
21 Light source
22 Condenser lens
3 Illumination pupil region
31 Apparatus
32 Illumination distribution
321 Light pole
322 Dipole-like light distribution
322a Outer dipole-like light distribution
322b Inner dipole-like light distribution
4 Photomask
41 Structures
42 SIG structure
43 Line-gap grating
5 Semiconductor wafer

What is claimed is:

1. An optical imaging device, comprising:
an apparatus operable to generate an illumination distribution in an illumination pupil region for photolithographic imaging of structures from a photomask into a photoresist layer formed on a semiconductor wafer, the illumination distribution including more than two light poles arranged in the illumination pupil region such that all the light poles lie on a same axis of an imaginary x, y axis system with an origin at the center of the illumination pupil region.

2. The optical imaging device according to claim 1, wherein the apparatus is operable to generate an illumination distribution that is axially symmetrical with respect to the x axis and the y axis of the x, y axis system.

3. The optical imaging device according to claim 1, wherein the apparatus generates an illumination distribution comprising an even number of light poles including pairs of light poles whose two light poles are at an identical distance from the origin and form a dipole-like light distribution.

4. The optical imaging device according to claim 3, wherein dipole-like light distributions of different pairs of light poles have different integral light intensities.

5. The optical imaging device according to claim 3, wherein dipole-like light distributions of different pairs of light poles have identical integral light intensities.

6. The optical imaging device according to claim 3, wherein the integral light intensity of an outer dipole-like light distribution is greater than the integral light intensity of an inner dipole-like light distribution.

7. The optical imaging device according to claim 1, wherein the illumination distribution comprises four light poles.

8. The optical imaging device according to claim 1, wherein the apparatus generates an illumination distribution that has no light pole at the origin of the x, y axis system.

9. An apparatus for generating an illumination distribution in an illumination pupil region of an optical imaging device, the apparatus being operable to generate an illumination distribution in an illumination pupil region for photolithographic imaging of structures from a photomask into a photoresist layer formed on a semiconductor wafer, wherein the illumination distribution generated by the apparatus comprises more than two light poles arranged in the illumination pupil region such that all the light poles lie on a same axis of an imaginary x, y axis system with an origin at the center of the illumination pupil region.

10. The apparatus for generating an illumination distribution according to claim 9, wherein the illumination distribution generated by the apparatus is axially symmetrical with respect to the x axis and the y axis of the x, y axis system.

11. The apparatus for generating an illumination distribution according to claim 9, wherein the illumination distribution generated by the apparatus further comprises an even number of light poles, including pairs of light poles whose two light poles are at an identical distance from the origin and form a dipole-like light distribution.

12. The apparatus for generating an illumination distribution according to claim 11, wherein dipole-like light distributions of different pairs of light poles have different integral light intensities.

13. The apparatus for generating an illumination distribution according to claim 11, wherein dipole-like light distributions of different pairs of light poles have identical integral light intensities.

14. The apparatus for generating an illumination distribution according to claim 11, wherein the integral light intensity of an outer dipole-like light distribution is greater than the integral light intensity of an inner dipole-like light distribution.

15. The apparatus for generating an illumination distribution according to claim 9, wherein the illumination distribution has four light poles.

16. The apparatus for generating an illumination distribution according to claim 9, wherein the apparatus generates an illumination distribution having no light pole at the origin of the x, y axis system.

17. The apparatus according to claim 9, wherein the apparatus is any of: a diaphragm, a diffractive optical element, or a lens system.

18. A method for determining an illumination distribution in the illumination pupil region of an imaging device according to claim 3, comprising:
providing the illumination distribution in a manner comprising dipole-like light distributions; and
defining the distances between the light poles that form the dipole-like light distributions with regard to distances between the structures in the photomask.
